(19) United States
(12) Patent Application Publication
(10) Pub. No.: US 2016/0125380 A1
(43) Pub. Date: May 5, 2016

(54) APPARATUS AND METHODS FOR COMMUNICATING ASSET INFORMATION

(71) Applicant: Autronic Plastics, Inc., Westbury, NY (US)

(72) Inventor: Michael Lax, Laurel Hollow, NY (US)

(21) Appl. No.: 14/557,358

(22) Filed: Dec. 1, 2014

Related U.S. Application Data
(63) Continuation of application No. 13/209,831, filed on Aug. 15, 2011, now abandoned.
Application No. 13/209,831 is a division of application No. 10/776,583, filed on Feb. 10, 2004, now abandoned.
(60) Provisional application No. 60/446,386, filed on Feb. 10, 2003.
(60) Provisional application No. 60/487,467, filed on Jul. 14, 2003.

(51) Int. Cl. G06Q 20/20; G06F 21/62

(52) U.S. Cl. CPC G06Q 20/206; G06F 21/6218

(57) ABSTRACT

Apparatus and methods for use with a security system such as a benefit denial system may involve a containing element configured to receive an asset that may include a benefit for a user of the asset. The apparatus may include an electrical circuit operatively associated with the containing element and configured to communicate information to a receiver outside the containing element. The information may be configured to be used by the benefit denial system to provide the benefit to the user. Apparatus and methods for executing a conveyance of an interest in an asset from a first party to a second party may involve a containing element having an electrical circuit configured to communicate information corresponding to the asset to a receiver outside the containing element. An electrical circuit may be provided with means for destruction of the circuit by an asset user.

### CROSS-REFERENCES TO RELATED APPLICATIONS

This application is a continuation of U.S. application Ser. No. 13/209,831 filed Aug. 15, 2011, which is a divisional of U.S. application Ser. No. 10/776,583 filed Feb. 10, 2004, which claims the benefit of U.S. Provisional Applications Nos. 60/446,386, filed Feb. 10, 2003 and 60/487,467, filed Jul. 14, 2003; each of which are incorporated by reference herein in their entireties.

### BACKGROUND OF THE INVENTION

The present invention relates to apparatus and methods for implementing systems such as a benefit denial system, a point-of-sale activation or delivery system and a consignment sale system.

Such systems may provide a consumer with a physical asset at a point of sale (which, as used herein, will also include a “point of rental” or any other distribution point) and require that the consumer use security information to obtain a benefit from the asset. A benefit denial system may deny a benefit to an unauthorized asset user and provide the benefit or permit access to the benefit to an authorized asset user.

The security information may be provided to the consumer at the point of sale. The security information may be stored with the asset in a form that is unusable by or inaccessible to the consumer until the consumer pays for the asset. The consumer is thus denied a benefit of the asset until the consumer pays for the asset. An entity that holds a right (a “rights holder” or “content provider”), such as an ownership right, in the asset and conveys the right to the consumer is thus provided with protection against piracy and unauthorized reproduction of the benefit because, in some instances, a pirate would be required to obtain the security information before acquiring the benefit. Furthermore, if a pirate were to sell unauthorized copies of the asset and provide buyers with security information, the rights-holding entity could deny the benefit to buyers who use duplicated security information or security information corresponding to a stolen asset.

An asset may be, for example without limitation, a CD, a CD-ROM, a DVD or a mini DVD. Such an asset is frequently stored in a storage case. The storage case may be displayed in an environment in which potential customers or users pick up and examine the storage case to determine whether they are interested in buying, renting or otherwise acquiring the asset.

Known benefit denial systems for assets require security information to be stored on a card. The card must be “swiped” at the point of sale. Swiping is time-consuming and decreases the efficiency of point-of-sale processes such as check-out. The card is exposed to viewing and tampering. Tampering may defeat the effectiveness of a benefit denial system.

When an asset is stolen from an entity that sells or rents such assets, or when an asset is lost or destroyed, the entity may suffer economic damage to the extent that the entity owned the asset when it was stolen or lost.

It would be desirable, therefore, to provide improved apparatus and methods for providing security information at a point of sale.

It would be further desirable, therefore, to provide apparatus and methods for preventing tampering with a device that retains security information.

It would be still further desirable, therefore, to provide apparatus and methods for reducing risk of economic loss to an entity selling or renting an asset.

### SUMMARY OF THE INVENTION

It is an object of this invention to provide improved apparatus and methods for providing security information at a point of sale.

It is a another object of this invention to provide apparatus and methods for preventing tampering with a device that retains security information.

It is yet another object of this invention to provide apparatus and methods for reducing risk of economic loss to an entity selling or renting an asset.

In accordance with the principles of the invention, apparatus and methods for providing security information at a point of sale; apparatus and methods for preventing tampering with a device that retains security information; and apparatus and methods for reducing the risk of economic loss to an entity selling or renting an asset are provided.

In some embodiments of the invention, an apparatus for use with a benefit denial system is provided. The apparatus may include a containing element configured to receive an asset. The asset may include a benefit for a user of the asset. The apparatus may include an electrical circuit that includes an antenna and is operatively associated with the containing element and configured to communicate information corresponding to the asset to a receiver outside the containing element. The information may be configured to be used by the benefit denial system to provide the benefit to the user.

In some embodiments of the invention, a container for use with a system for executing a conveyance of an interest in an asset from a first party to a second party is provided. The container may include a containing element configured to receive the asset and an electrical circuit operatively associated with the containing element and configured to communicate information corresponding to the asset to a receiver outside the containing element. The information may be configured to be used by the system to execute the conveyance.

In some embodiments of the invention, a container for an asset is provided. The container may include a containing element configured to receive the asset and an electrical circuit attached to the containing element and configured to communicate information corresponding to the asset to a receiver outside the containing element. The invention may include a circuit deactivator configured to interrupt electrical communication within the circuit.

In some embodiments of the invention, a locking member for use with 1) a benefit denial system; and 2) a lockable container, including a locking channel and configured to enclose an asset that includes a benefit for a user of the asset, is provided. The locking member may include an electrical circuit configured to communicate information associated with the asset to a receiver outside the container and may include a base configured to be inserted in the channel when the container is closed. The base may be configured to support the circuit and the information may be configured to be used by the system to provide the benefit to the user.

In some embodiments of the invention, a method for providing a benefit of an asset to an asset user may be provided. The method may include receiving asset identification information transmitted by an antenna enclosed in a containing element; and providing access information corresponding to the asset identification information to the user. The access information may be configured to provide the user with access to the benefit.

In some embodiments of the invention, a method for transacting a consignment sale of an asset may be provided. The method may include receiving information from an antenna enclosed in a containing element that may enclose the asset; communicating sale information to a first party having an ownership interest in the asset; and communicating access information to a second party, who is acquiring the interest.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIG. 1 is a schematic diagram of apparatus, systems and information in accordance with the principles of the invention;

FIG. 2 is a perspective view of apparatus in accordance with the principles of the invention;

FIGS. 3A and 3B are perspective views of another apparatus in accordance with the principles of the invention in two different states;

FIG. 3C is an enlarged view of a portion of the apparatus shown in FIG. 3B;

FIG. 4 is a schematic diagram of a relationship between apparatus and information according to the principles of the invention;

FIG. 5 is an illustrative diagram showing steps that may be included in a method in accordance with the principles of the invention;

FIG. 6 is another illustrative diagram showing steps that may be included in a method in accordance with the principles of the invention;

FIG. 7 is yet another illustrative diagram showing steps that may be included in a method in accordance with the principles of the invention;

FIG. 8 is a perspective view of yet another apparatus according to the principles of the invention;

FIG. 9 is a detailed view of the apparatus shown in FIG. 8 in a state that is different from that shown in FIG. 8; and

FIG. 10 is a detailed view of the apparatus shown in FIG. 8 in another state that is different from that shown in FIG. 8.

### DETAILED DESCRIPTION OF THE INVENTION

In some embodiments, the invention may provide an apparatus for use with a benefit denial system. The apparatus may include a containing element that is configured to receive an asset. The asset may include a benefit for a user of the asset. The benefit may be derived from data encoded within the asset. The benefit may be derived from data encoded on the asset. The container may include an electrical circuit for communicating information via an antenna to a receiver outside the containing element when the containing element is closed and the circuit is disposed within the containing element. The circuit may communicate information to the receiver when the containing element is open. The circuit may communicate the information to the receiver when the asset is enclosed inside the containing element. The circuit may communicate the information to the receiver when the asset is locked inside the containing element.

The information may configured to be used by the system to provide the benefit to the user. The information may be required by the system to provide the benefit to the user.

The apparatus may include a locking element configured to lock the containing element in a closed state. The electrical circuit may be affixed to the locking element. The electrical circuit may be affixed to the containing element.

Examples of an asset containing element and apparatus for locking the containing element are shown and described in U.S. patent application Publications Nos. 2002/0023853, 2003/0000856 and 2003/0111367; in U.S. Provisional Applications Nos. 60/456,996, filed Mar. 21, 2003, 60/458,028, filed Mar. 26, 2003, 60/505,496, filed Sep. 24, 2003 and 60/530,529, filed Dec. 17, 2003 and in U.S. application Ser. No. 10/723,911, filed Nov. 24, 2003, all of which are hereby incorporated by reference herein in their entireties.

The examples include locking members that are operated by inserting the locking member into, and removing the locking member from, the containing element. The examples include locking members that are internal to the containing element and are operated by moving the locking member from one position inside the containing member to another.

The circuit may include a data storage device. The device may be an integrated circuit chip. The device may be programmable. The digital storage device may be any suitable device and may include, for example without limitation, one or more of erasable programmable read-only memory, programmable read-only memory, read-only memory, electrically erasable read-only memory, and random access memory. The circuit device may include an integrated circuit chip.

In some embodiments of the invention, one circuit may be included in an electronic article surveillance (“EAS”) tag. The EAS tag may be configured to trigger an alarm if an article to which the tag is attached is moved into proximity with a detector that senses the presence of the tag.

In embodiments in which the electrical circuit is affixed to the locking element, the data storage device may be a reprogrammable device. In embodiments in which the electrical circuit is affixed to the locking element, the data storage device may be a reburnable device. Reprogrammable or reburnable devices may be reprogrammed or reburned, respectively, to reconfigure the electrical circuit to communicate information associated with a different asset. For example, a first asset may be removed from the containing element and a second asset may be placed in the containing element. If so, the electrical circuit may be reconfigured to communicate information associated with the second asset.

The circuit may include an antenna, which may be any suitable antenna, including without limitation any suitable dielectric resonator of any suitable geometry. The circuit may include or be part of a contactless smart card such as that sold under the name GemEasy 8000 by Gemplus Corp. of Horsham, Pa. The circuit may include or be part of a contactless smart object such as that sold under the name MA8000 by Gemplus of Horsham, Pa.

The asset may have a type. For example without limitation, the asset may be a compact disc, a digital video disc, a digital versatile disc, a memory card, a memory cartridge, a memory chip, or any other suitable data storage or recording medium. In some embodiments, the asset may be a consumer product. The apparatus may be configured to enclose no more than three assets of a type. The apparatus may be configured to enclose no more than two assets of a type. The apparatus may be configured to enclose no more than one asset of a type.

The benefit may include any suitable product or service. The benefit may include any suitable data. The benefit may include an executable computer program. The benefit may include a game. The benefit may include audio data. The benefit may include visual data. The benefit may include data that are inactive before the system receives a portion of the information. Inactive data may be unusable until they are activated. The system may be configured to activate the data.

The data may be configured to be accessed using an access device. The access device may be, for example without limitation, a personal computer, a work station, a mobile telephone, a personal data assistant, a game system (for example, without limitation, systems such as those sold under the trademarks GAMECUBE and GAMEBOY, by Nintendo of America, Inc. of Richmond, Wash.; PLAYSTATION, by Sony Corporation of America, Inc. of New York City, N.Y. and XBOX, by Microsoft Corporation of Redmond, Wash.) and any other suitable access device. In some embodiments, the access device may require at least a portion of the information to provide the benefit to the user.

In some embodiments of the invention, the system may be configured to provide a data key to the device. In some embodiments of the invention, the user may request the data key from the system via telephonic communication. The telephonic communication may include voice communication. The telephonic communication may include telephone keypad tones. In response to the request, the system may provide the data key to the user. The user may communicate the data key to the access device.

The data key may be configured to activate the data. The data key may include data. The data key may be a file that is required for a user to obtain the benefit. The file may be an executable file. The file may be a non-executable file. The file may include decryption information. The file may include one or more license numbers for one or more licenses. Each license may entitle the user to obtain the benefit. Each license may entitle the user to obtain a portion of the benefit. A license may require that the user obtain the benefit using a single access device. The access device may be identified to the system by the user. The access device may be identified to the system by the access device.

The information may include security data configured to be communicated by the user to the system. The security data may include an access code or a personal identification number (hereinafter, “PIN”). The information may include encoded letters, numbers, or any other suitable symbols.

The information may include transaction data configured to be communicated by the receiver to the system. The transaction data may be communicated to the system to confirm that the asset was conveyed to the user via an authentic transaction. As used herein, an authentic transaction may be a transaction that is authorized by an entity that owns or possesses or is conveying a copyright, patent right, trademark right, trade secret, or other right or intellectual property right in the asset. The transaction data may include data related to the sale or rental of the asset.

The apparatus may include optically opaque material. The optically opaque material may make it impossible for a viewer to perceive the presence or location of the circuit inside the container. The containing element may be entirely opaque.

The circuit may communicate the information using a radio frequency signal. The circuit may be a passive circuit such as a passive radio frequency identification (“RFID”) circuit. The circuit may be part of an RFID tag. The circuit may be an active RFID circuit.

In some embodiments, the invention may provide a container for use with a system for executing a conveyance of an interest in an asset from a first party to a second party. The container may include a containing element configured to receive and enclose the asset; and an electrical circuit configured to communicate information corresponding to the asset to a receiver outside the containing element when the containing element is closed and the circuit is disposed within the containing element. The information may be configured to be used by the system to execute the conveyance.

The circuit may be configured to communicate the information when the asset is enclosed within the containing element. The circuit is may be configured to communicate the information when the asset is locked in the containing element.

The information may be required by the system to execute the conveyance, which may be a consignment sale. The interest may include an ownership interest in the asset. The interest may include a right to use the asset. The circuit may be configured to communicate the information before a third party places the asset in the possession of the second party. The third party may be a vendor, for example without limitation, a retailer, a wholesaler, a rental agent, or any other suitable entity. The third party may be an entity that does not hold an ownership interest in the asset during the conveyance.

In some embodiments, the invention may provide an asset container that may include a containing element configured to receive and enclose the asset; an electrical circuit configured to communicate information corresponding to the asset to a receiver outside said containing element when the containing element is closed and the circuit is disposed within the containing element; and a circuit deactivator configured to interrupt electrical communication within the circuit. The circuit may be configured to communicate the information when the asset is enclosed within the containing element.

The deactivator may be configured to interrupt electrical communication between a first portion of the circuit and a second portion of the circuit. The first portion may include a digital data storage device. The second portion may include an antenna. The deactivator may be configured to interrupt the electrical communication by physically separating the first and second portions of the circuit. The deactivator may be configured to be operated manually by a user of the asset.

The information may be configured to be used by a benefit denial system to provide to a user access to a benefit. The information may be required by the benefit denial system to provide the access. The information may be configured to be used by an asset transaction system to convey an interest in the asset from an interest conveyor to an interest receiver. The information may be required by the asset transaction system.

In some embodiments, the invention may provide a method for providing a benefit of an asset to an asset user. The method may include receiving asset identification information transmitted by an antenna enclosed in a containing element; and providing access information corresponding to the asset identification information to the user. The access information may be configured to provide the user with access to the benefit.

The method may include providing the access information to the user via a point-of-sale entity. The method may include notifying a content provider regarding that the user has initiated a purchase of the asset. The content provider may be an entity that owns or possesses or is conveying a copyright, patent right, trademark right, trade secret, or other right or intellectual property right in the asset.

The method may include providing a label to the user. The label may bear at least a portion of the access information (such as a PIN). The label may be configured to adhere to the container. The portion may be human-readable. The portion may be machine readable. The portion may include a bar code.

The asset identification information may include an electronic product code. The asset identification information may include a universal product code.

The method may include activating the benefit. The activating may include identifying the access information as active access information. The access information may be stored in a storage device and electronically identified as “active.”

The method may include receiving the access information from the user. The method may include providing to the user a key to the benefit if the access information received from the user corresponds to access information identified in the storage device as activated access information. The key may serve to activate the asset. The key may serve to activate the benefit.

It will be appreciated that, according to the principles of the invention, the terms “active”, “activating” and “activated”, as applied to access information, refer to the process by which a system (such as a benefit denial system) designates that a benefit corresponding to the access information will be conferred to a user if the user presents the access information (or a facsimile thereof) to the system. The system may then activate the benefit by providing information required to provide the benefit to the user. If the user presents access information (or a facsimile thereof) that does not correspond to activated access information, system will not activate the benefit and the user will be denied the benefit.

The method may include receiving access device information corresponding to a device used to access the benefit and associating the access device information with the access information. In some embodiments, the association of access device information with access information may be used to deny a user the benefit unless the user accesses the benefit from the access device.

In some embodiments, the invention may provide a method for transacting a consignment sale of an asset. The method may include receiving information from an antenna enclosed in a containing element that may enclose the asset; communicating sale information to a first party having an ownership interest in the asset; and communicating access information to a second party, who is acquiring the interest.

The method may include receiving the access information from the user. The method may include unlocking data from the asset. The unlocking may include providing to an access device information configured to activate the data.

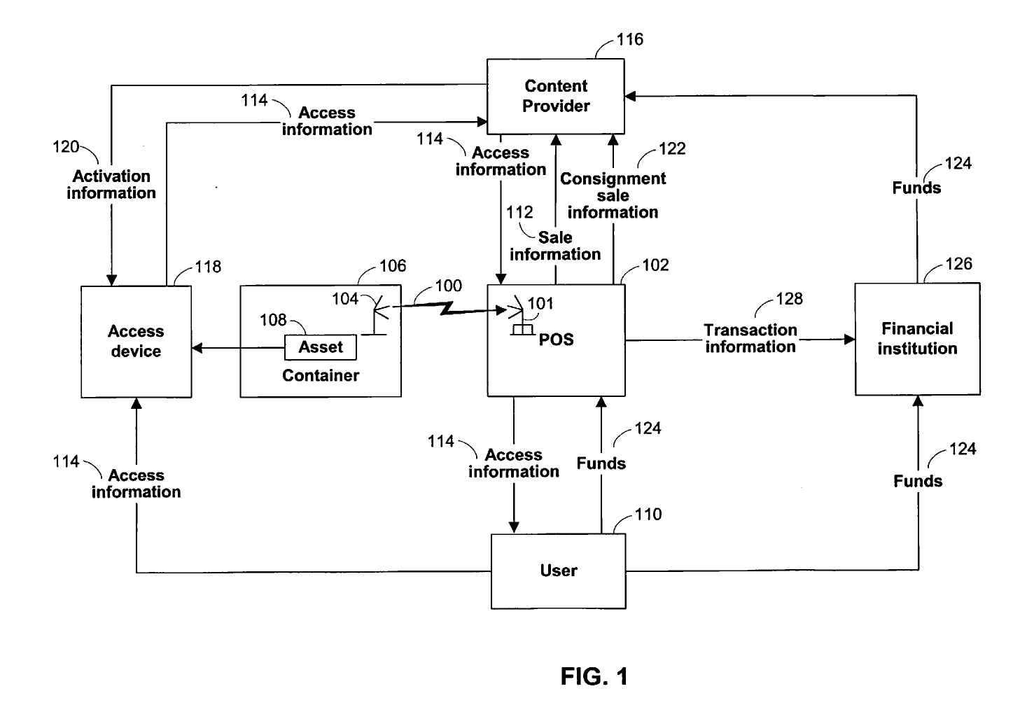

A number of features of illustrative embodiments of the invention are shown in FIGS. 1-10.

FIG. 1 shows illustrative information 100 that may be communicated between container 106, which may include antenna 104, and system 102, which may include transceiver 101. System 102 may be associated with a point-of-sale (“POS”) system at an asset retail or rental facility. For the purpose of illustration, system 102 will be described as being associated with a retail sales facility. Information 100 may be associated with asset 108. Information 100 may include security information that is required for user 110 to access asset 108 or a portion of asset 108. Information 100 may be required for user 110 to obtain a benefit present on or in asset 108.

In some embodiments, information 100 may be required to initiate a process that provides user 110 with access information 114 that may enable user 110 to access asset 108 or obtain a benefit present on or in asset 108. In some embodiments, information 100 may be required to initiate a process that provides user 110 with activation information 120 that may activate a benefit present on or in asset 108. For the purpose of illustration, the benefit will be described as the use of an electronic game.

User 110 may purchase asset 108 and execute the purchase by interacting with system 102. System 102 may receive information 100 using transceiver 101. Information 100 may be transmitted by antenna 104 on a radio frequency carrier signal. In some embodiments, system 102 may transmit sale information 112, which may be derived from or included in information 100, to content provider 116. It will be understood that the functions described herein as being performed by content provider 116 may be performed by any suitable party using one or more of a system for processing data, a system for communicating data, a system for storing data and any other suitable system. The system or systems may be centralized. The system or systems may be distributed over one or more physical devices. The physical devices may be located in different geographic locations.

System 102 may communicate with content provider 116 via a computer network such as the Internet, a virtual private network or other suitable secure data circuit, or an intranet, via a telephone network, via a wireless communication channel, or via any other suitable communication channel. Sale information 112 may inform content provider 116 that asset 108 has been or is to be sold to user 110 and that the sale occurred through system 102. Content provider 116 may therefore recognize the sale of asset 108 as an authorized or authentic sale. Content provider 116 may provide access information 114 to user 110. In some embodiments, content provider 116 may provide access information 114 to user 110 via system 102. In some embodiments, content provider 116 may provide access information 114 to user 110 via a route (not shown) that is independent of system 102. Access information 114 may be communicated to user 110 via a computer network such as the Internet or an intranet, via a telephone network, via a wireless communication channel, or via any other suitable communication channel.

System 102 may provide access information 114, which may be derived from or be included in information 100, to user 110. User 110 may use access information 114 in conjunction with access device 118 to access or play a computer game stored on asset 108. Access device 118 may be an access device such as any of those described above. It will be assumed for the sake of illustration that the access device is an electronic game system.

In some embodiments, user 110 may “keyboard” access information 114 into access device 118. Access device 118 may communicate access information 114 to content provider 116. Content provider 116 may identify access information 114 as being authorized access information and may provide activation information 120 to user 110, for example via access device 118. Communication between content provider 116 and access device 118 may be via a computer network such as the Internet or an intranet, via a telephone network, via a wireless communication channel, or via any other suitable communication channel.

In some embodiments of the invention, asset 108 may instruct access device 118 to communicate with content provider 116. Asset 108 may include a log-in procedure that prevents access device 118 from launching the computer game until access device receives activation information 120. Access device 118 may display a screen that prompts user 110 to enter some or all of access information 114 into access device 118. After access device 118 receives activation information 120, access device 118 may launch the electronic game. User 110 may then obtain the benefit of playing the electronic game.

In some embodiments, information 100 may include activation information 114 that is provided to user 110 by system 102. In those embodiments, it may not be necessary for system 102 to provide sale information 112 to content provider 116, for content provider 116 to provide access information 114 to user 110, or for access device 118 to communicate with content provider 116. In some of those embodiments, user 110 may keyboard access information into access device 118. Asset 108 may instruct access device 118 to launch the electronic game upon receipt by access device 118 of the activation information.

In some embodiments of the invention, access device 118 may be provided with a transceiver that is configured to communicate directly with antenna 104. In those embodiments, user 110 may place container 106 in communication with access device 118 to transfer any portion of information 100 required for access to asset 108, or a benefit present in or on asset 108, to access device 118.

In some embodiments of the invention, access device 118 may not be in communication with content provider 116. For example, access device 118 may not have an Internet interface. User 110 may communicate with content provider 116 by telephone. User 110 may provide access information 114 to content provider 116 via telephone. Content provider 116 may provide activation information 120 to user 110. User 110 may enter activation information 120 into access device 118 to gain access to the electronic game.

In some embodiments of the invention, information 100 may be used to execute a consignment sale of asset 108. The consignment sale may be a transaction between content provider 116 and user 110. The sale may be facilitated by system 102. The retail sales facility may not own asset 108. The retail sales facility may own asset 108, but may not own the computer game stored on asset 108. Therefore, if asset 108 is lost or stolen, the retail sales facility may lose the value of asset 108 in its inactive state, but may be spared the loss of the electronic game value.

System 102 may provide consignment sale information 122 to content provider 116. Consignment sale information 122 may inform content provider 116 that user 110 has purchased or has agreed to purchase asset 108 and the computer game present on asset 108. Content provider may provide access information to user 110 to enable user 110 to play the electronic game, as described above. User 110 may provide funds 124 to the retail sales facility associated with system 102. User 110 may provide funds 124 to content provider 116 via financial institution 126. System 102 may facility the transfer of funds 124 by providing transaction information 128, which may be credit card information, to financial institution 126. Any of the aforementioned communications in connection with the consignment sale may be performed via a computer network such as the Internet or an intranet, via a telephone network, via a wireless communication channel, or via any other suitable communication channel.

It will be understood that in some embodiments of the invention, information 100 may include security information that is required for user 110 to access asset 108 or a portion of asset 108. In some embodiments, information 100 may include information that may be used to execute a consignment sale of asset 108. In some embodiments, information 100 may include both security information that is required for user 110 to access asset 108, or a portion of asset 108, and information that may be used to execute a consignment sale of asset 108.

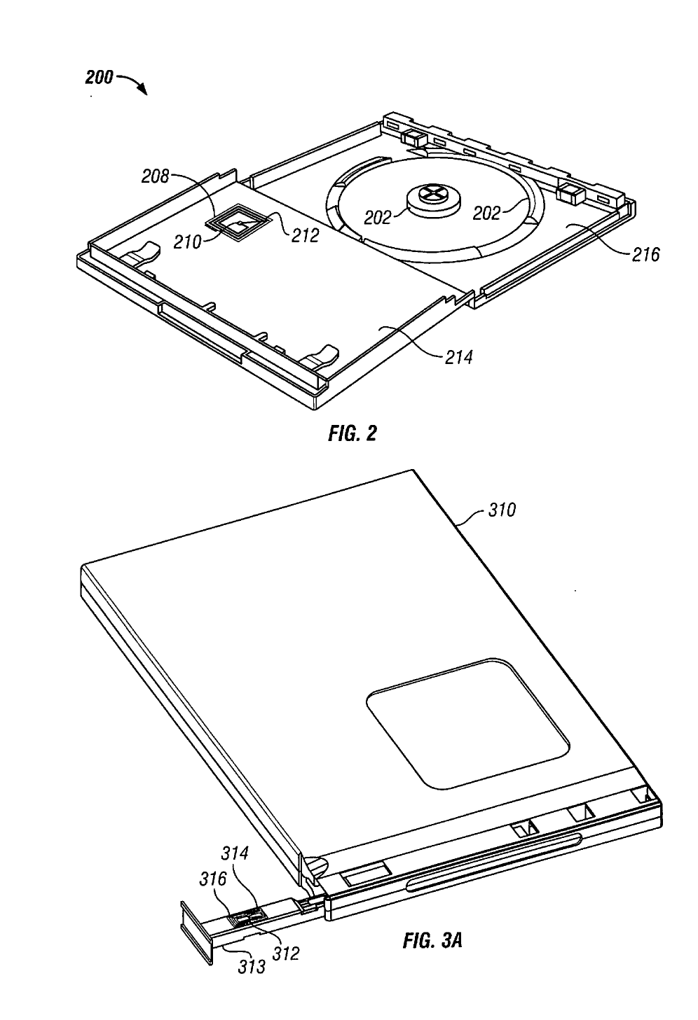

FIG. 2 shows illustrative container 200 that may include illustrative asset support structures 202. Asset support structures 202 may be present to receive an asset (not shown). Although asset support structures 202 are configured to support an item such as an optical disc, asset support structures in accordance with the principles of the invention may be configured to support any type of item, including any type of consumer item. In some embodiments of the invention, asset support structures may not be present.

Container 200 may include any suitable structures for locking container 200 in a closed state. Tag 208, which may include data chip 210 and antenna 212, may be present on enclosure member 214, which may be positioned opposite enclosure member 216 when container 200 is closed. Tag 208 may transmit information corresponding to information 100 (shown in FIG. 1).

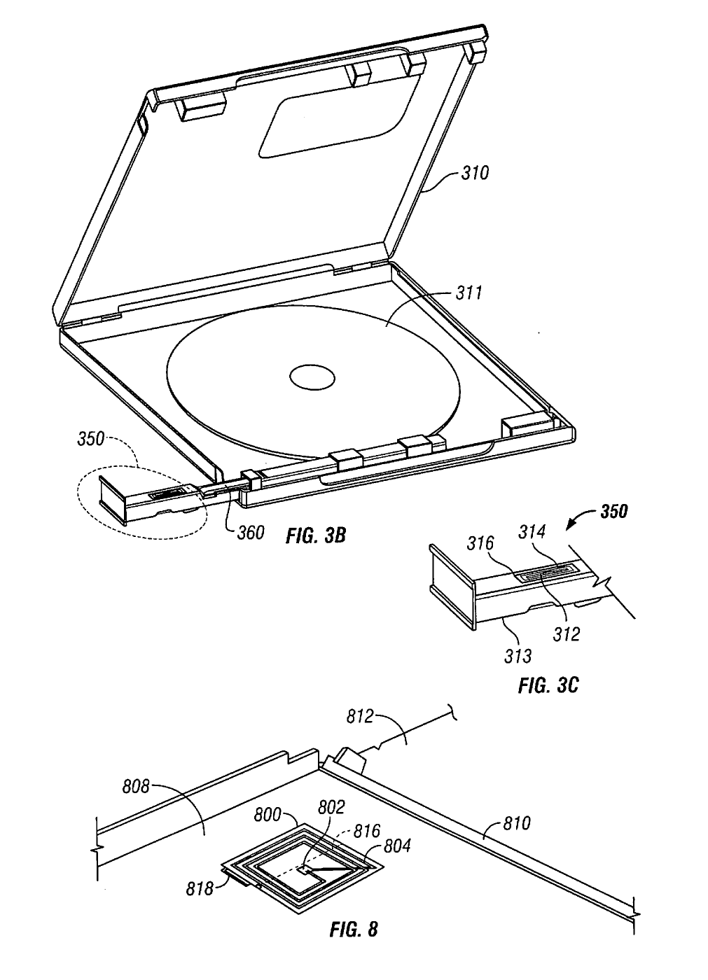

FIGS. 3A and 3B show illustrative storage case 310, which may contain inactive storage medium 311. Locking mechanism 313, which may engage container 310 via a catch mechanism (not shown) supported by spring arm 360, may support tag 316, which may include integrated circuit chip 312. Locking mechanism 313 may be inserted in storage case 310 to lock the case in a closed state (shown in FIG. 3A). FIG. 3C is an enlarged view of portion 350 (as identified in FIG. 3B) of locking mechanism 313, which supports tag 316. Antenna 314, which may be an RF coil, may be used to transmit information to a system such as system 102 (shown in FIG. 1). Locking mechanism 313, along with chip 312, may be removable from container 310. Locking mechanism 313, along with chip 312, may be reusable. By affixing the chip to a removable locking mechanism, costly chips can be reused, thereby promoting cost savings and reducing waste.

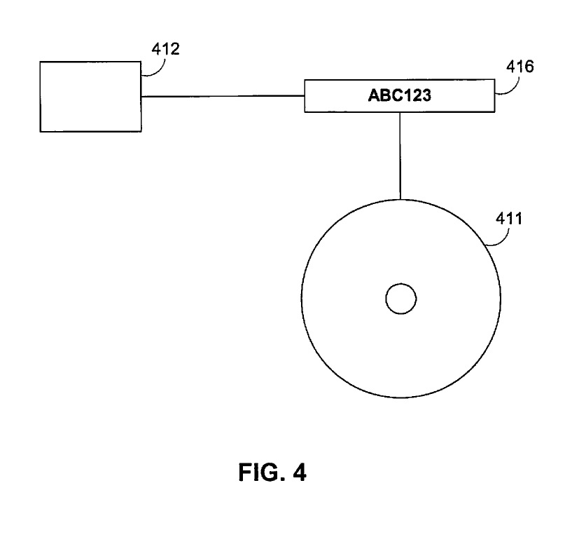

FIG. 4 shows integrated chip 412, which may include code 416, which may be an alphanumeric code, that may function as a key to unlock and activate the contents of storage medium 411. For example, code 416 (“ABC123”) may be required by an access device such as 118 (shown in FIG. 1) in order to launch an application stored or encoded in medium 411. Security code 416 may be selected to activate only the storage medium contained in storage case 310 (shown in FIGS. 3A and 3B). Once locking mechanism 313 (shown in FIGS. 3A and 3B) is removed from storage case 310, chip 412 may be read by a system such as 102 (shown in FIG. 1) using any of the known methods to reveal the required security code. For purposes of illustration, storage medium 411 may be any medium capable of storing multi-media content, including, for example without limitation, a CD-ROM, a DVD, an audio CD and the like. Security code 416 may be saved in integrated circuit chip 412. Security code 416 may be saved in storage medium 411.

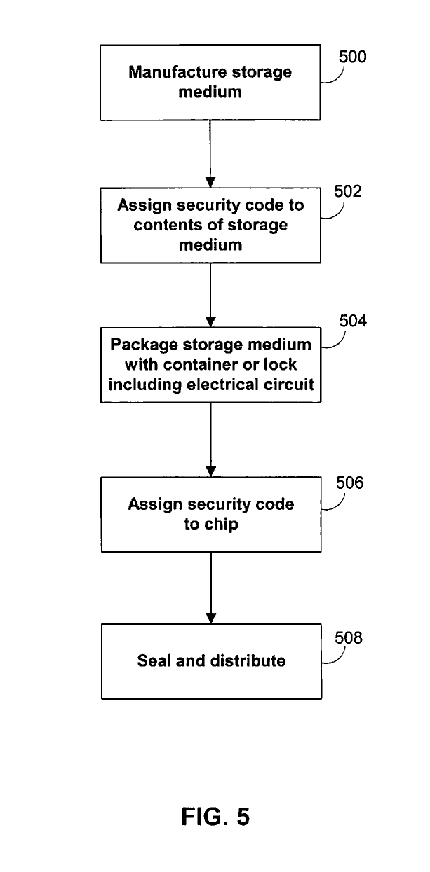

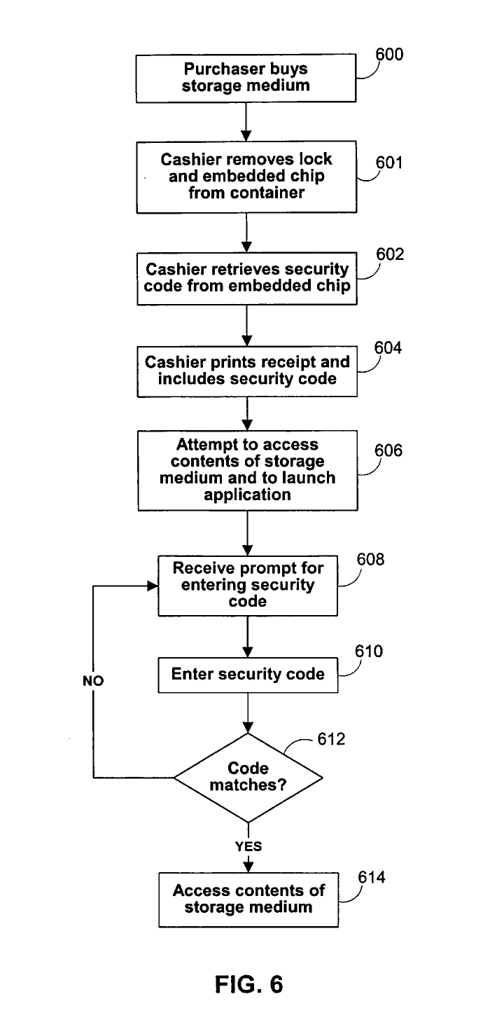

FIGS. 5-7 show general flowcharts of illustrative steps involved in using some embodiments of the present invention. The steps shown in FIGS. 5 and 6 are only illustrative and may be performed in any suitable order. In practice, there may be additional steps or some of the steps may be deleted.

FIG. 5 shows illustrative steps for implementing a benefit denial system in accordance with the present invention. In step 500, a manufacturer may manufacture a storage medium. In step 502, the manufacturer may be provided a security code which is assigned to the storage medium. The security code may function as a key to unlock the contents of the storage medium.

The security code may be included in the storage medium and, in step 504, the medium may be placed into a case. In step 506, a security code may be stored in a chip, which may be affixed to a locking mechanism for the storage case. In step 508, the locking mechanism may be inserted into the storage case to lock the case. The storage case and storage medium may be sealed and made ready for distribution. In this way, a security code is effectively associated with a storage medium and a storage case.

Although the steps shown in FIG. 5 appear in a sequence, the invention is not so limited. For example, it is envisioned that storage cases may be manufactured with integrated circuit chips each having a security code already programmed therein. In such a case, when a storage medium is manufactured, the already-programmed chip (which may be affixed to a locking mechanism) is referenced, and the chip is programmed to receive the security code that is to function as a key for accessing the contents of the storage medium.

FIG. 6 shows a flowchart of illustrative steps, in accordance with the present invention, for retrieving a security code from a container and launching an application stored in storage medium. In step 600, a purchaser may buy a storage medium. In some embodiments, at the point of sale, in step 601, a cashier may remove a locking mechanism and retain the locking member and a chip affixed to the locking mechanism. In some embodiments, the chip may be affixed to the container. In those embodiments, the chip may remain affixed to the container at the point of sale.

In step 602, the cashier may use a device capable of extracting information from the chip to retrieve a security code. The security code may be retrieved by any of the known methods, e.g., by utilizing a device that reads the code embedded in the chip, or by utilizing a device that uses the chip to direct the cashier, for example, over the internet to a network which transmits the security code back to the cashier. In some embodiments, including some embodiments using the latter method, point of sale information concerning the medium can be transmitted to, and received by, the game manufacturer or the like. Point-of-sale information may include, for example, the name of a store where the medium was purchased, the price of the medium, demographic information, or any other suitable information.

In step 604, the cashier may present the security code to the purchaser. For example, the cashier may generate a purchase receipt showing the retrieved security code.

In step 606, a user, who may be the purchaser, may open the storage case and retrieve the storage medium and place the medium in an appropriate access device for accessing and/or running the contents of the storage medium.

The user may attempt to launch an application stored in the storage medium. In step 608 the user may receive a prompt to enter the security code that was printed on the receipt in step 604. In step 610, the user may enter the security code. In step 612, a determination may be made whether the security code entered by the user matches the security code that is embedded in the storage medium. The determination may be made by the access device. The determination may be made by a remote device in communication, for example via a network, such as the Internet, with the access device.

If the security code that is entered by the user does not match the security code that is stored on the storage medium, then the process may loop back to step 608 and the user may again be prompted to enter a security code. If the user enters a security code that matches the security code that is stored in the storage medium, then, for example, the application may be launched and some or all of the contents stored in the storage medium may become available to the user.

Although the process steps described in the flowchart in FIG. 6 are shown in a sequence, and, further, include specific steps, the invention is not so limited. For example, it is envisioned that a device which is capable of accessing the contents of a storage medium and of running applications stored therein, for example, a device such as that sold under the trademark GAMECUBE by Nintendo of America, Inc., can then automatically access a security code without user intervention. This can occur, for example, when an integrated circuit chip is affixed to a storage case, rather than a locking mechanism, and a receiving device stored in the playing device that is capable of accessing the information stored on the chip reads the code.

The examples and embodiments shown herein involve a one-to-one correspondence between a security code and a storage medium. For example, one security code is assigned to one storage medium only. However, the invention is not so limited. For example, a plurality of security codes can be used for a plurality of storage medium. In such an embodiment, for example, security code ABC123 will function as a key to unlock an electronic baseball game from a DVD game disk. Security code DEF456 will also function as a key to open the same baseball game on the same storage medium 11. Security code ABC123 may function as a key for a different game, for example, a football electronic game. By using a plurality of security codes for a plurality of storage media, managing the processes associated with the present invention may be simplified. For example, in a distribution of 10,000 DVD disks, it may be easier to assign any one of 10,000 security codes to any one of the storage medium rather than require a specific security code for a specific storage medium.

In some embodiments, one security code may be used for a plurality of storage media. In some embodiments, a plurality of security codes may be used for a single storage medium. In some embodiments, a security code may correspond to a storage medium itself, rather than contents of the medium.

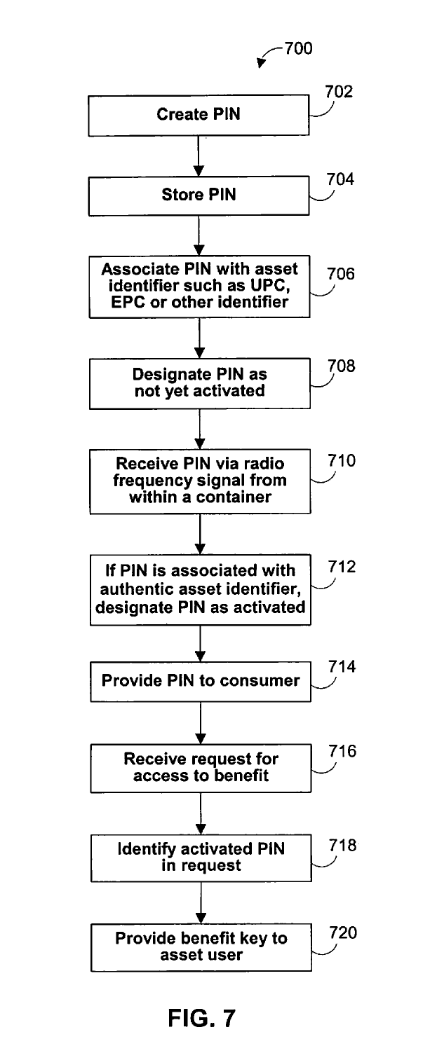

FIG. 7 shows steps of illustrative method 700, which may be used to implement a benefit denial system for an asset to be sold to a consumer. In step 702, the system may create a PIN. (In some embodiments of the invention, the PIN may correspond to access information 114 (shown in FIG. 1). In some embodiments of the invention, the PIN may correspond to the security code of step 602 (shown in FIG. 6).) In step 704, the system may store the PIN in any suitable data storage device. The PIN may be stored in a PIN database. In step 706, the system may associate the PIN with an asset identifier. The identifier may be a unique asset identifier. The identifier may be a Universal Product Code. The identifier may be an Electronic Product Code. It will be understood that the PIN and the identifier may be associated in connection with the production and packaging of the asset as discussed in connection with steps shown in FIG. 5.

In step 708, the stored PIN may be designated as an inactivated PIN. An attempt to obtain a benefit from the asset would thus be denied. The asset may be offered for sale in a container. When the asset is processed for sale, the PIN, which may have been encoded in an electrical circuit in the container (for example, see FIG. 5), may be transmitted to the system. In step 710, the system may receive the PIN via a radio frequency signal from within the container. In step 712, the system may activate the PIN in the database by re-designating the PIN as being activated. In some embodiments, the system may activate the PIN only after verifying that the PIN corresponds to an asset that was authentically offered for sale. Such a verification may be based, for example, on a unique asset identifier and any associated inventory information. For example, the system may verify that the asset is being processed for sale or rent by an entity that is authorized to do so. If the PIN was already activated, the system may communicate, to an individual involved in the sale of the asset, for example, that the PIN was previously activated and that the asset is not available to be sold.

Provided that the system activates the PIN, in step 714, the system may provide the PIN to the consumer. The consumer may complete the purchase of the asset and, using an asset access device such as access device 118 (shown in FIG. 1), attempt to obtain the benefit from the asset. The consumer may request access to the benefit by providing the PIN to the system. The system may receive the PIN in step 716. In step 718, the system may determine that the PIN received in step 716 is an activated PIN. In step 720, the system may provide a benefit key to the consumer. The benefit key may correspond to activation information 120 (shown in FIG. 1). The system may deny the benefit key to the consumer if the PIN is not activated. It will be understood that method 700 may be configured to provide benefit denial in connection with numerous assets, each of which may be associated with one or more PINS, but that method 700 is illustrated in FIG. 7 in connection with one asset and one PIN for the sake of simplicity.

FIG. 8 shows illustrative tag 800 that may be used in accordance with the principles of the invention. Tag 800 may include integrated circuit chip 802, which may be in electrical communication with antenna 804 to communicate information such as information 100 (shown in FIG. 1) to a system such as system 102 (shown in FIG. 1). Tag 800 may be present on enclosure member 808 of a container such as container 200 (shown in FIG. 2). Enclosure member 808 may be an inside surface of container 200 when container 200 is closed. Enclosure member 808 may be coupled by spine 810 to enclosure member 812.

Tag 800 may be fixed to enclosure member 808 and may include perforation 816 that may be positioned near circuit 800. A user may use tab 818 of tag 800 to tear tag 800 along perforation 816. When tag 800 is torn along perforation 816, tag 800 may be rendered inoperable. In some embodiments, perforation 816 may transect antenna 804. When circuit 800 is inoperable, it may not operate to communicate information such as information 100 (shown in FIG. 1). In some embodiments of the invention, tag 800 may be configured to be rendered inoperable by providing a user with any suitable apparatus for disfiguring a portion of antenna 804. In some embodiments of the invention, tag 800 may be configured to be rendered inoperable by providing a user with any suitable apparatus for separating chip 802 from antenna 804. The apparatus may be thread, wire, paper, plastic, or any other suitable means for rendering tag 800 inoperable.

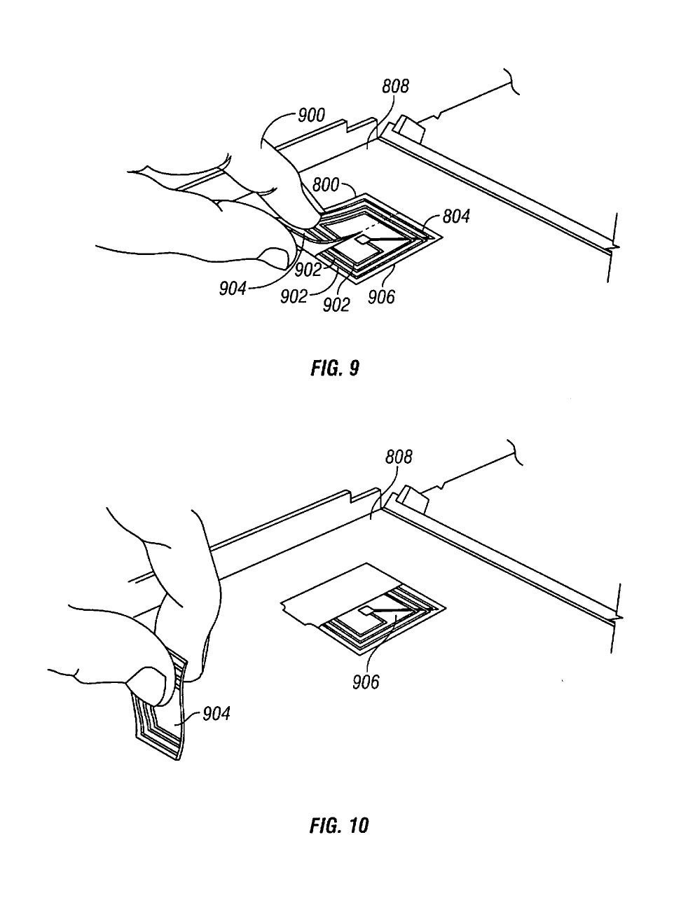

FIG. 9 shows user hand 900 rendering tag 800 inoperable by tearing tag 800 along perforation 816 to destroy coils 902 of antenna 804. Portion 904 of tag 800 may be detached from enclosure member 808. Portion 906 of tag 800 may remain attached to enclosure member 808.

FIG. 10 shows portion 904 removed from enclosure member 808 and portion 906 remaining attached to enclosure member 808. In some embodiments, all of tag 800 may be removed from enclosure member 808.

Thus it is seen that apparatus and methods for providing security information at a point of sale; preventing tampering with a device that retains security information; and reducing the risk of economic loss to an entity selling or renting an asset have been provided. One skilled in the art will appreciate that the present invention can be practiced by other than the described embodiments, which are presented for purposes of illustration and not of limitation, and the present invention is limited only by the claims which follow.

1. A method for providing a benefit of an asset to an asset user, said method comprising: receiving asset identification information transmitted by an antenna enclosed in a containing element; and providing access information corresponding to said asset identification information to said user, said access information configured to provide said user with access to said benefit.

2. The method of claim 1 further comprising activating said benefit.

3. The method of claim 2 wherein said activating comprises designating said access information as activated access information.

4. The method of claim 1 further comprising receiving said access information from said user.

5. The method of claim 4 further comprising providing to said user a key to said benefit if access information received from said user corresponds to access information identified as activated access information.

6. The method of claim 4 further comprising: receiving access device information corresponding to a device used to access said benefit; and associating said access device information with said access information.

7. The method of claim 1 wherein said providing comprises providing said access information via a point-of-sale entity.

8. The method of claim 1 further comprising notifying a content provider regarding said providing.

9. The method of claim 1 wherein said providing comprises providing a label to said user, said label bearing at least a portion of said access information, said label configured to adhere to said container.

10. The method of claim 9 wherein said at least a portion is human-readable.

11. The method of claim 9 wherein said at least a portion is machine readable.

12. The method of claim 1 wherein said asset identification information comprises an electronic product code.

13. The method of claim 1 wherein said asset identification information comprises a universal product code.

14. A method for transacting a consignment sale of an asset, said method comprising: receiving information from an electrical circuit enclosed in a containing element, said containing element enclosing said asset; communicating sale information to a first party having an ownership interest in said asset; and communicating access information to a second party, said second party acquiring said interest.

15. The method of claim 14 further comprising receiving said access information from said user.

16. The method of claim 14 further comprising providing to an access device information configured to activate said data.
